(19) United States
(12) Patent Application Publication
(10) Pub. No.: US 2018/0113217 A1
(43) Pub. Date: Apr. 26, 2018

(54) Equine Saddle Location Tracker System

(71) Applicant: Monty L. Ruetenik, Clear Lake City, TX (US)

(72) Inventor: Monty L. Ruetenik, Clear Lake City, TX (US)

(21) Appl. No.: 15/716,350

(22) Filed: Sep. 26, 2017

Related U.S. Application Data
(60) Provisional application No. 62/411,206, filed on Oct. 21, 2016.

(51) Int. Cl. G01S 19/14; G06Q 30/06; G01S 19/34; B68C 1/02; H02J 7/02; H02J 7/32; H02J 7/00

(52) U.S. Cl. CPC G01S 19/14; G06Q 30/0645; G01S 19/34; B68C 1/002; H02J 7/025; H02J 7/32; H02J 7/0013; B68C 1/025

(57) ABSTRACT

Disclosed is a Global Positioning System (GPS) location tracking system for equine saddles with battery charging means and/or charging protocols and, optionally, a saddle leasing method that takes advantage of the saddle tracking system. The tracking system may be an equine saddle having a tree, a cantle, a horn, a side, an underside and a saddle covering, a battery powered GPS location tracking module, and battery charging means attached to the structure of the saddle. The module will be adapted to communicate with a remote receiver/monitor, such as one located in a rental agency.

### CROSS REFERENCE TO RELATED APPLICATIONS

This application claims benefit of Provisional Patent Application Ser. No. 62/411,206 filed Oct. 21, 2016, the contents and disclosure of which is incorporated herein by reference in its entirety for all purposes.

### BACKGROUND

### Field of Disclosure

The field of disclosure is equine saddles, and specifically built-in tracking systems for equine saddles.

### Background

Global Positioning System (GPS) tracking systems for persons, animals, automobile, and other assets are commercially available. Most have relatively short battery lives—e.g. on the order about 30 hours or less unless equipped with relatively large battery packs. Some available trackers are designed to carried on the person, animal, or asset, and some are also built-in into systems such as into shoes (US20130088386, published Apr. 11, 2013). Since the battery life is relatively short, there needs to be an acceptable means for recharging the battery. T Numerous ways in which this can be accomplished exist. Wireless chargers that do not require electrical contact between the charging element and charger are becoming increasingly available.

High-end performance saddles can be very costly, running as much as $5,000 to $6,000. Having a tracking system on saddles has many advantages, including: enabling more secure rental of expensive performance saddles, providing better recovery assurance for insurance, tracking trail rides, or locating stolen equipment by law enforcement. The system of the present invention is suitable for both Western and English saddles. There is not, however, to the Applicant's knowledge, a suitable tracking system for equine saddles.

### BRIEF DESCRIPTION OF FIGURES

A more complete understanding of the present invention and certain advantages thereof may be acquired by referring to the following description in consideration with the accompanying drawings, in which like reference numbers indicate like features, and wherein:

FIG. 1 is a perspective of a Global Positioning System (GPS) tracking module of an embodiment of the invention.

FIG. 2 is a perspective of a power module of an embodiment of the invention.

FIG. 3 is a side view of an equine saddle of an embodiment of the invention.

FIG. 4 is a perspective view of an equine saddle and saddle stand showing the wireless charger placements of an embodiment of the invention.

### DETAILED DESCRIPTION OF EMBODIMENTS

In the following detailed description, reference is made to the accompanying drawings that form a part hereof, and in which is shown by way of illustration specific implementations (embodiments) which may be practiced. These implementations are described in sufficient detail to enable those skilled in the art to practice the implementations, and it is to be understood that other implementations may be utilized. Further, logical, mechanical, and other changes may be made without departing from the scope of the implementations. The following detailed description is, therefore, not to be taken in a limiting sense.

In broad aspect the present invention is a Global Positioning System (GPS) location tracking system for equine saddles with battery charging means and/or charging protocols and, in some embodiments, a saddle leasing method that takes advantage of the saddle tracking system. In some embodiments, the invention is a location tracking equine saddle tracking system comprising an equine saddle having a tree, a cantle, a horn, a side, an underside and a saddle covering, a battery powered GPS location tracking module and battery charging means embedded into the structure of the saddle. The module will be adapted to communicate with a remote receiver/monitor, such as one located in a rental agency.

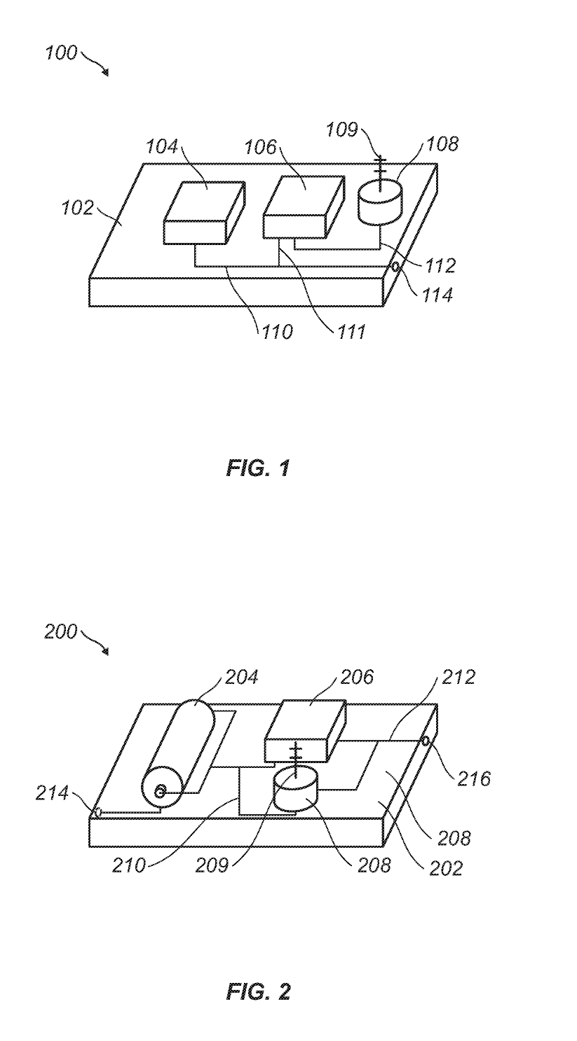

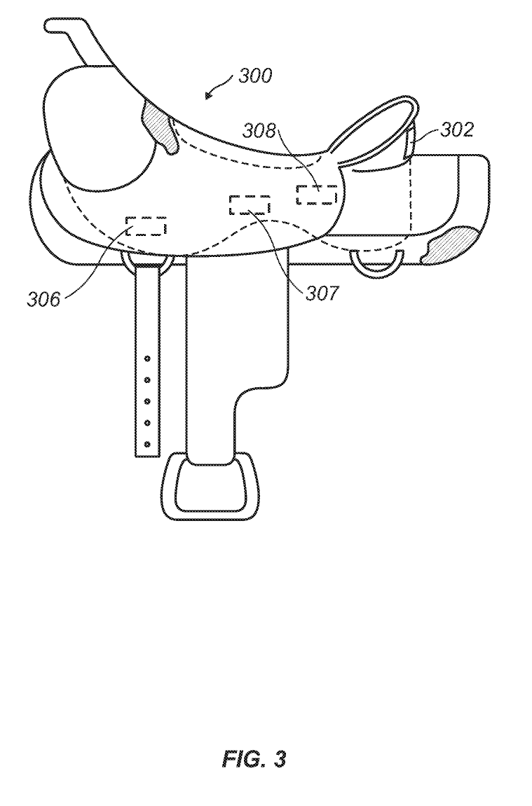

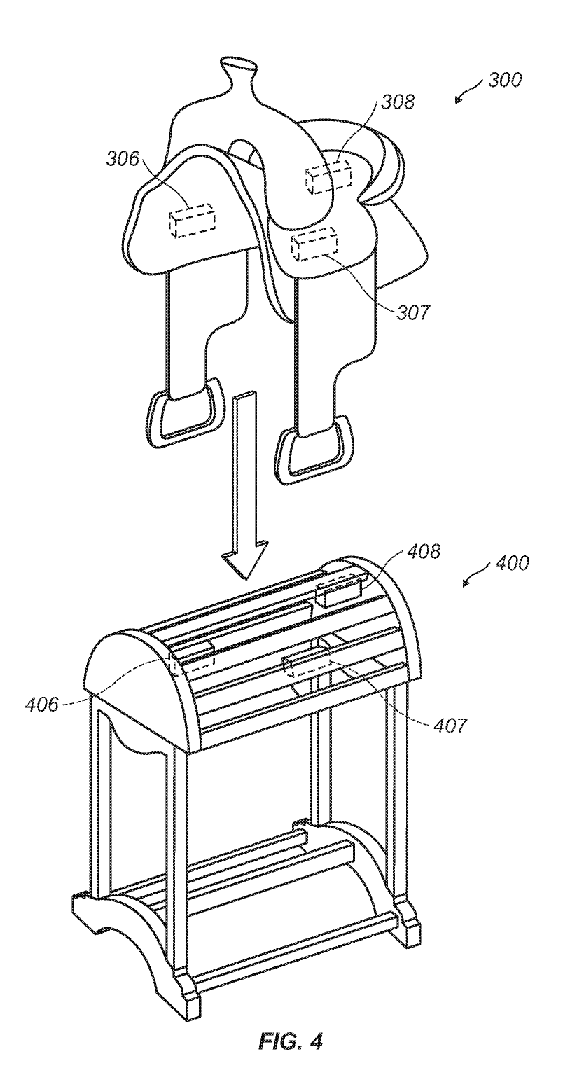

FIG. 1 is an illustrative tracking module of an embodiment of the invention. The module comprises a support (typically a circuit board) 100, with base 102 on which is disposed a GPS unit 104, a processing unit 106, a transmitter 108 (with an antenna 109). Item 108 may also be a transmitter/receiver. The three units 104, 106 and 108 are connected to a power source connector 114 through electric conduits 110, 111, 112. Electric power is supplied to the unit through connection 114 from a power module as illustrated in FIG. 2. Power may also be supplied by a wireless charging system. In FIG. 2, the illustrative power module 200 has base 202, a rechargeable battery 204 with outlet electrical connection 214 (to connect to 114 of a tracking module), a charger interface 206 or alternatively a wireless interface 208 (with antenna 209). The battery 204 is connected, 212, to the respective interfaces. Power is supplied to recharge the battery through connector 216, which is connected to an external power transformer configured to charge the battery 204, or by a wireless charging system. The battery may be two or more stacked batteries connected in parallel as described below. The GPS module attached to the rear of the cantle as illustrated in FIG. 3 (302) is preferable.

The tracking module will comprise, at least, a GPS unit and means for wirelessly transmitting information to a remote monitor and optionally receiving programming information for the GPS unit to a receiver (monitor). The monitor is programmed to receive the transmitted information, process it, and display it. Such monitors used in commercial vehicle and asset tracking systems are suitable or can be adapted to be suitable. Such tracking systems are described in numerous patent documents including, U.S. Pat. No. 5,905,461, U.S. Pat. No. 7,312,752, U.S. Pat. No. 7,015,817, U.S. Pat. No. 6,720,870, U.S. Pat. No. 8,398,560 and patent published applications 2013/0088386 and WO 2004/08462. The relevant technical disclosures of these patents and applications are incorporated herein by reference. The transmitting means may be via Wi-Fi, but it is preferable to utilize a satellite-based transmission as in cell phone transition and reception. A power module will contain a battery (or battery pack), and connections (wired or wireless) for recharging, as described in reference to FIG. 2. Optionally, the tracking module will also contain a means for providing a signal to indicate that a battery charge is needed. The battery charge signal means may be as simple as a pre-set (or adjustable) timer, but preferably, it will be comprised of a means to detect and signal a diminishing battery charge. The battery charge signal will be connected to indication means such as an LED light or sound-generating device (or both) that will alert the user (and optionally remotely to a monitor as in a lease situation) that the battery must be charged. The tracking module is placed in any convenient location on or is embedded in the saddle such as the tree of the saddle, or behind, or on the the two opposing sides of the cantle. The GPS modules will also, optionally, contain means to provide a signal for transmittal if it is disconnected from the saddle. This may be a switch sensor that is tripped when the module is disconnected from its mount in the saddle. The modules are sized and located so as to not interfere with the flex and dynamics of the saddle tree. The power module may also be placed in any convenient location that does not interfere with the shape and fit of the saddle.

The tracking system can also be programmed to be adjusted and/or controlled remotely. This will allow, for example, for setting faster pings if a renter is suspected of avoiding payment and.or saddle return. Also pinging can be set on a sliding scale so that early in a rental or lease period the ping frequency can be correlated to payments or adjusted when a payment is missed. The key is to not have constant tracking for the battery life extension.

The tracking module will preferably be encased in a polymer housing or coating, such as a polyurethane gel coating to protect it from damage and wear.

For long term use, obtaining sufficiently extended battery or recharging protocols is a challenge. Generally, battery life is about 30 days (30 hours of battery life) or less when the system is used intermittently (e.g. 1 hr/day for 30 days). The tracking system can be programmed to activate (ping) only occasionally, as for example, once a week or once a month. In many situations, such as saddle rental, this extended interval will be entirelysufficient since the object of tracking is principally to recover the saddle if the rental (lease) is broken. This will allow extended use on a battery charge. The system is equipped with a device (or method) that provides a reminder (visual, sound, or both) to prompt the user of the need to recharge. In the case of rented equipment, or other party interest (other than user), the system can also optionally provide a wireless signal to such party. For example, in the case of rented equipment, the renter may receive a reminder signal —and if the battery is not recharged, the rental agreement may be voided and the customer requested to eturn the saddle. Also for rental purposes, a rental contract may require periodic return for cleaning and inspection (for example, once or twice a year). The batteries can be recharged or replaced at that time by the renter or renter's agent. The availability of longer life batteries will allow the recharge interval to be extended. Batteries may also be stacked (connected in parallel, series, or combinations of parallel and series). Parallel connection of stacked batteries will prolong life. Battery stacking may be accomplished by known methods by those skilled in the art.

Additionally the saddle will, in some embodimentshave an RFID chip embedded. RFID chips are relatively inexpensive and may be associated with identifiers to allow monitoring of a variety of desirable information such as: identification, source, inventory and order tracking, intellectual property rights and obligations, date of manufacture, date of application, composition, quantity of application, and the like.

### Charging

Recharging the batteries may be accomplished by any of several means:

1.) Wired charging where a charger transformer (to provide appropriate DC voltage) is connected to the battery terminals. Charging terminals will be positioned on the saddle in a protected and inconspicuous location and can be connected to the charger transformer and power module. Convenient placement of the charger transformer will be apparent to the user and will include, for example, on a portable unit, located in a stall, a trailer, or mounted on a saddle rack.
2.) Piezoelectric cells can be embedded in saddle tree, leather covering of the tree, and other areas of the saddle and in cantle. Cells placed in the cantle and seat of the saddle between the saddle tree are very suitable to reduce any interference with the tree structure especiallysince these are locations of constant pressure and movement. Movement and pressure on the piezoelectric cells provide electrical charges to charge the battery. Such piezoelectric charging (as for cell phones) is known and can easily be provided by those skilled in the art. See for, example, U.S. Pat. No. 6,257,336, U.S. Pat. No. 8354,778, and published applications, U.S. 2004/0085002, and U.S. 2008/0252174, the disclosures of which are incorporated herein by reference.
3.) Wireless chargers. For example, a saddle rack or saddle blanket that fits over a rack is fitted with a charger unit comprising a transformer to produce suitable DC charge connected to contact surfaces on the top side and contact points, positioned to engage matching contact points on the underside of a saddle. Thus, when the saddle is placed on a rack or blanket, the tracking system batteries will be charged. Providing the charging contacts in a blanket or something similar provides flexibility in location of the charging unit—it can be accomplished in a stall, trailer, or at shows and events. Wireless charging systems are commercially available and will be very suitable for this service. See for,example www.ti.com/lsds/ti/power-management/wireless-power-receiver-solutions-overview.page, and energous.com/.

Embodiments of charging systems and modules are illustrated in FIGS. 3 and 4. FIG. 3 is a “Western” saddle showing the GPS control system, 302, (described above in reference to FIG. 1 and 2). Also shown are wireless charger receivers 306, 307, and 308 that (as shown in FIG. 4, are positioned to mate with wireless charger transmitters 406, 407, and 408 in a saddle stand. The receivers are integrated with the underside of the saddle in positions that do not result in distortion or discomfort to the equine or rider. Suitable wireless charging systems are commercially available and or can be adapted from available systems. See for example, Lu, et al, Wireless Charging Technologies: Fundamentals, Standards, and Network Applications; IEEE Communications Surveys and Tutorials; arXiv:1509.00940[csNI]; available at arxiv.org/pdf/1509.00940.pdf. The disclosure of this reference is incorporated herein by reference.

FIG. 3 is also illustrative of the placement of piezoelectric cells that can also be represented by 306, 307, and 308. Any suitable number of cells can be used. They are connected together and connected to the power supply unit illustrated in FIG. 2. If grouped, they will provide sufficient power to keep the GPS system power supply charged. The pressure on and movement of the saddle will cause the piezoelectric cell to produce electrical current. See U.S. published patent application, U.S. 2008/0252174, Oct. 16, 2006, the disclosure of which is incorporated herein by reference.

### Saddle Leasing Method

In one embodiment, an application of the saddle tracking system described above is used in a saddle leasing (or rental) method. The method comprises:

1. providing to a customer a saddle having a GPS tracking module(s) and battery and battery charging module(s) with, optionally, a battery recharge reminder signal generator and tracking monitor means as described above;

2. providing, optionally, means for the tracking system to be programmed remotely to allow pinging to be set on be on a sliding scale so that early in a rental period the ping frequency can be correlated to payments or when a payment is missed;

3. providing to a customer a rental or lease agreement that encompasses, inter alia:
a.) the stipulation that the customer recharges the battery when signaled to do so by the charging module;
b.) the periodic return of the saddle to the owner or entity providing the saddle and lease for service that may include inspection, cleaning, battery recharge or replacement.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense. Therefore, the scope of the invention should be limited only by the appended claims.

1. An equine saddle location tracking system comprising an equine saddle having a tree, a cantle, a horn, a top side, an underside and a saddle covering, a battery powered location tracking module having a GPS unit and transmitting means, a remote monitor, and battery charging means attached to the structure of the saddle.

2. The system of claim 1 wherein the GPS location module is programmed to transmit intermittently at pre-set intervals.

3. The system of claim 1 wherein the GPS location module also comprises a signal receiving means.

4. The system of claim 1 wherein the charging means comprises a piezoelectric cell or a wireless charging system.

5. The battery charging means comprises a battery pack containing two or more batteries connected in parallel.

6. The system of claim 1 also comprising a saddle rack having disposed thereon wireless charging units positioned to mate with receiving units on the underside of the saddle.

7. The system of claim 1 also comprising a piezoelectric cell attached to the underside of the saddle and electrically connected to the charging module.

8. An equine saddle leasing method comprising:
1) providing to a customer a saddle with a GPS tracking module(s) and battery and battery charging module(s) with optionally a battery recharge reminder signal generator and tracking monitor means as described above; and
2) providing to a customer a rental or lease agreement that provides a reminder for the customer, inter alia:
a.) to recharge the battery when signaled to do so by the charging module;
b.) to periodically return of the saddle to the owner or entity providing the saddle as well as lease for service that may include inspection, cleaning, battery recharge or replacement.

9. The equine saddle leasing method of claim 8 also comprising providing means for the tracking system to be programmed remotely to allow pinging to be set on a sliding scale so that early in a lease period the ping frequency can be correlated to payments or adjusted when a payment is missed.

10. The equine saddle leasing method of claim 8 wherein the saddle with a GPS tracking module(s) and battery and battery charging module(s) comprises:
